(19) United States
(12) Patent Application Publication
(10) Pub. No.: US 2002/0044254 A1
(43) Pub. Date: Apr. 18, 2002

(54) Tinted contact lens and method for treatment of migraine headaches

(76) Inventor: Kathleen Saathoff, Houston, TX (US)

Correspondence Address: Shawn Hunter, BRACEWELL & PATTERSON, L.L.P., P. O. Box 61389, Houston, TX, 77208-1389, US

(21) Appl. No.: 09/976,502

(22) Filed: Oct. 12, 2001

Related U.S. Application Data
(60) Provisional application No. 60/239,773, filed on Oct. 12, 2000.

(51) Int. Cl. G02C 7/04; G02C 7/10

(52) U.S. Cl. 351/163; 351/160 R

(57) ABSTRACT

Devices and methods are described for treatment of migraine headaches in a patient by selectively filtering out certain targeted portions of light within the visible spectrum from entering the patient's eye. In exemplary embodiments, contact lenses are disposed in one or both eyes of the patient for treatment. The lenses are preferably of a rust red or dark red color. It is also preferred that approximately 80% of the targeted portions of the visible spectrum be blocked.

### CROSS-REFERENCED TO RELATED APPLICATIONS

This application claims the priority of U.S. Provisional Patent Application No. 60/239,773 filed Oct. 12, 2000.

### BACKGROUND OF THE INVENTION

1. Field of the Invention

The present invention relates to the treatment of migraine headaches. More specifically, the present invention relates to tinted contact lenses for insertion into the eyes of patients to decrease As or eliminate migraine headache pain.

2. Description of the Prior Art

Traditionally, migraine headache sufferers have been treated by medication, adjustments to diet, or simply by suggestions that the patient rest or remain inactive until the headache subsided. Many of the medications prescribed for treatment of migraine headaches had side effects, such as chest pain and palpitations causing fatigue, dizziness, or disorientation. The result was that in order to relieve the pain from the headache, the patient often suffered intolerable medication side effects and often became incapacitated by the medication. Similarly, requiring that the patient rest or remain inactive caused severe interruptions to the patient's life and substantially reduced their ability to work. As far as is known, none of these treatments actually targeted the underlying cause of the migraine pain, but simply attempted to deaden or lessen the pain while the migraine ran its course.

The inventor has recognized that some of the symptoms that characterize migraine headaches are similar to symptoms suffered by patients with cone/rod dystrophy. Cone/Rod Dystrophy is a disorder, which is characterized by, among other symptoms painful sensitivity to light, which prevents them from functioning in any normal illumination.

It has now been recognized by the inventor that many normally sighted patients suffering from migraine headaches present symptoms which are remarkably similar to the symptoms presented by Cone/Rod Dystrophy patients. More recently, after trying many kinds of glasses and filters, the inventor used contact lenses to prevent leaks of light from entering the eye. Such patents were able to tolerate light with the control of the light spectrum beams provided by the contact lenses. Prior to the present invention, no migraine headache patient had been treated using tinted contact lenses. There has been a long felt need for a migraine headache treatment that did not use medication, which substantially or completely ehiminated all migraine headache symptoms, and which allowed a patient to lead a normal life very shortly after treatment. The present invention has fulfilled this long felt need by treating migraine headache patients with tinted or colored contact lenses as more fully described below.

### SUMMARY OF THE INVENTION

Devices and methods are described for treatment of migraine headaches in a patient by selectively filtering out certain portions of the visible spectrum from entering the patient's eye. In exemplary embodiments, contact lenses are disposed in one or both eyes of the patient for treatment.

The lenses are preferably of a rust red or dark red color. It is also preferred that approximately 80% or more of the ambient light be blocked.

### DETAILED DESCRIPTION OF THE PREFERRED EMBODIMENTS

Migraine headaches are very painful (vascular) headaches and are commonly associated with irritability, nausea, vomiting and photophobia. Photophobia is an abnormal and painful visual intolerance to light stimulus to the visual system. Migraine headache symptoms can often be disabling enough while they last as to prevent the patient's normal life activities, such as working and socializing, until the symptoms subside. Millions of Americans miss 5 or more days of work and productivity a month while suffering the pain of migraine headaches.

It has now been found that by preventing certain colors and intensities of light from entering the migraine patient's eyes, the symptoms associated with migraine headaches may be alleviated, reduced or completely eliminated. It has also been found that one way of effectively preventing light from entering the patient's eyes is to insert a colored contact lens into the eye of the patient.

A contact lens is simply a curved, shell-like piece of transparent material such as plastic or other synthetic material which may be placed over some or all of the front surface of the eye such as the cornea of the eye. Generally, contact lens refers to any lens that is placed on the surface of the cornea or the sclera of the eye, and refers to either hard or soft lenses. There are many types of contact lenses, including but not limited to lenses that cover only the cornea, and lenses that bridge the limbus and lie partially on the conjunctival tissues which overlie the sclera. The present invention is not limited to any particular variety of contact lens but instead may be used in conjunction with any contact lens that is suitable for placement in the eye of a patient.

Contact lenses are commonly used to correct vision problems, such as myopia. It is well known that contact lenses may be colored, painted or tinted. Normally, contact lenses are painted or colored for cosmetic reasons, such as to cover a disfigured eye, or to make the eye more attractive. It has been found that the same principles used to paint or tint a contact lens for cosmetic reasons may be used to tint or color a contact lens to block out light. The present invention is not limited to any particular type of paint, tint or coloring, nor is it limited to any particular method of painting, tinting or coloring. Rather, the present invention contemplates that contact lenses may be painted, tinted or colored using any conventional means which is safe for use with contact lenses.

Standard contact lenses may be obtained from many conventional sources for contact lenses. The contact lenses of the present invention may be piano, meaning that they have no refractive strength, or may be designed to correct the patient's vision. The contact lens may be tinted to a specified color and transmissibility of light using conventional technology. When the lens is placed over the cornea of the patient's eye, the coloration of the lens blocks out some of the light that would normally enter the pupil of the eye. It has been found that filtering portions of the light spectrum has a surprising and dramatic effect on migraine headache symptoms. It has been found that some patients using the contact lenses of the present invention have their migraine headache symptoms substantially alleviated. Other patients using the contact lenses of the present invention have experienced a complete recovery from all migraine symptoms.

As is well known, electromagnetic energy may be emitted or radiated from any number of sources, including the sun, television and radio transmitters, microwave ovens, and ultraviolet lights. Electromagnetic radiation travels through space at the speed of light as orthogonal pairs of sinusoidal electric and magnetic waves. As with any sinusoidal wave, electromagnetic waves can be described as having a frequency and a wavelength. Because the speed of an electromagnetic wave through space is constant, there is a direct inverse relationship between the wavelength and the frequency of the wave. Therefore, only one of frequency or wavelength need be known to adequately describe the electromagnetic wave. The continuum of all possible electromagnetic waves figuratively arranged according to their wavelength is referred to as the electromagnetic spectrum. Only a very small segment of all electromagnetic waves are visible to the human eye. This segment of the electromagnetic spectrum which is visible to the human eye is referred to as the visible spectrum. Commonly, visible electromagnetic radiation is simply referred to as light. Different wavelengths of light appear to the human eye as having different colors, and within the visible spectrum, there are many colors of light that can be seen. Generally, that visible light which has a wavelength of from about 400 nanometers (each nanometer is equal to 1×10⁻⁹ meters) to about 500 nanometers is commonly referred to as being in the blue part of the spectrum. That light which has a wavelength of from about 500 nanometers to about 600 nanometers is referred to as being in the green part of the electromagnetic spectrum. That light which has a wavelength of from about 600 nanometers to about 700 nanometers is referred to as being in the red part of the spectrum. Light having a wavelength of less than about 400 nanometers is generally not visible to the human eye. That light which has a wavelength of greater than about 700 nanometers is also generally not visible to the human eye.

Of course, the visible spectrum contains a continuum of colors ranging from deep violet to dark red. Accordingly, the part of the visible spectrum referred to herein as “blue” may range from wavelengths of light appearing as violet to wavelengths of light appearing as bluish-green. The division of the visible spectrum into blue, green and red should not therefore be construed as a limitation on the present invention, but instead should be understood as being a convenient generalized way of referring to large portions of the visual spectrum.

It is well known that a transparent material, such as hydrogel acrylic is a common material used in the manufacture of contact lenses, will allow light of all visible wavelengths to pass through it. Generally, for people who require only vision correction from a contact lens, it is desirable to construct the lens of a transparent material because there is no need to block out any light. On the other hand, some patients may require some light to be blocked out. For these patients, it is preferable that the contact lens be colored, tinted or painted. It has been found that coloring a transparent material with the appropriate type of paint, dye or other substance suitable for coloring contact lens materials, will block out parts of the electromagnetic spectrum, while allowing other parts of the electromagnetic spectrum to pass through unhindered. For example, using a color that appears substantially red to the human eye will block out some or all of the blue and green parts of the visual spectrum, while allowing much of the red portion of the visual spectrum to pass through. Other colors may block out other parts of the visual spectrum.

The present invention contemplates that various colors may be effectively used for relieving the pain of migraine headaches. One such color is that which is commonly referred to as red. It should be understood that the spectral characteristics may have many variations and may cover color spectrum that is commonly referred by other names, including but not limited to “pink,” “rust,” “amber,” “orange.” Each spectral characteristic may block out more of the different portions of the visual spectrum.

It has been found that standard contact lenses colored to a rust-red color yield very surprising results and have been found to eliminate migraine symptoms within minutes of their insertion into the eyes of the patient. It should be understood that the color rust-red as used herein may be described differently by different people. Some might be inclined to refer to rust red as clay-red, or maybe brownish-red. However, rust-red is a lens color that was determined through trial and error. Migraine patients were treated by placing a tinted lens in their eye. This lens color was chosen on a comparison basis of prior therapeutic trials of spectacles and other lenses, etc., as to what color best suited the patient based upon experience and the symptoms reported by the patient. The patient would then be questioned as to how they felt and whether a different color would be better. Based upon the desires of the patient as well as knowledge and experience, a new lens was ordered having an adjusted color. The new lens was tried and the patient would be questioned again. Using this iterative process on the small sample of patients described below, it was determined that the color rust-red was very effective in treating migraine headache pain. It may be that a similar iterative process used on a larger or different population of patients will yield a different shade of red as the color that best relieves migraine symptoms. The present invention is not limited to “rust-red.”

It has also been found that by blocking out some or all of the blue portion of the visual light spectrum, migraine headache symptoms may be relieved or eliminated. In one embodiment of the present invention, the contact lenses are colored to substantially match the color of a CPF® 550 lens made by Corning Glass Works of New York. According to the present invention, the colored contact lens may filter light in the blue end of the visual electromagnetic spectrum. Alternatively, the lens of the present invention may filter light in both the blue and green parts of the electromagnetic spectrum. Preferably, the lenses filter out light having a wavelength of from about 411 nanometers to about 550 nanometers. In a preferred embodiment, the lenses filter out about 80% of the wavelengths of light between about 411 nanometers and about 550 nanometers. In a further preferred embodiment, the lenses filter out about 80% of the wavelengths of light in the visual spectrum. Stated otherwise, only 20% of the wavelengths of visible light pass through the lens. In another embodiment, the lenses filter out about 80% of the visible electromagnetic energy. In other words, the lenses allow about 20% of the visible electromagnetic energy to pass through the lenses. The lenses may also filter out light in the non-visible ranges of the spectrum.

In one embodiment of the present invention, migraine headache symptoms maybe relieved by inserting one dark red lens into each of the patient's eyes. Alternatively, one lens substantially matching both the color and transmissibility of light of the Corning CPF® 550 lens may be placed in each of the patient's eyes. It also may be desired to place one rust-red lens in each of the patient's eyes. It also may be preferred, depending upon the pain that the patient is experiencing, and the activities that the patient will have to carry out while wearing the lenses to use a combination of colors of lenses. For example, one dark red lens may be placed in one of the patient's eyes, and one rust-red lens may be placed in the patient's other eye. Any other combination of colors may also be employed. In one embodiment of the present invention, where two different color lenses are used, the darker of the two lenses is placed in the eye corresponding to the side of the head where the greatest head pain is occurring.

In practice, procurement and coloration of the lenses begins with ordering a standard clear lense from a company in the business of supplying standard contact lenses. Preferably, the lens is made of a material which is 55% water methafilcon A, which allows oxygen to pass through the lens to the cornea. Other materials, such as those listed above, may be used as desired. Next, the lenses are sent to a company, such as Adventures in Color, Inc. of Colorado to be colored. Companies, such as Adventures in Color are able to accurately color a contact lens if given a sample of the desired color, and data as to which part of the visual spectrum is to be blocked out by the tint. Such companies can control the part of the electromagnetic spectrum that is to be blocked, and can control the percentage of any particular wavelength of light that is to be allowed through the lens. The appropriately colored lenses may then be placed in the patient's eyes to relieve the migraine pain.

Determination of the appropriate color to be used in any given patient may be a trial and error process. It maybe desirable to start with rust-red and then ask the patient if they desire a lighter or darker color. The patient may, for example, work at night, in which case a lighter color may best suit their needs. On the other hand, the patient may work outdoors in the sun, in which case a darker color may be desirable.

### EXAMPLES

The first patient to be treated with colored contact lenses was diagnosed by a medical doctor as experiencing migraine headaches and as having optic nervehead drusen in both eyes. Initial observation of the patient during her first office visit revealed that the patient had her eyes closed, was wearing dark sunglasses and had to be lead by the hand while walking. These traits have also been observed in patients having Cone/Rod Dystrophy. The patient complained of migraine headache pain, that glare from the sun made her eyes hurt, that she could only see large print and could not see the television. She displayed symptoms of photophobia and extreme blephorospasm. The patient reported that she wore dark gray sunglasses with a color classification of G15. The patient could not be examined with the room lights on because her eyes were very sensitive to light.

Her vision was reported to be 20/400 in both eyes without glasses. However, she could not even open her eyes to be examined on the day of the office visit due to the severity of her migraine headache pain. No improvement could be made to her vision due to the fact that without light she could not see, and the migraine induced photophobia prevented any light from being introduced. This problem was recognized to be very similar to the problems experienced by Cone/Rod Dystrophy patients, though this patient did not suffer from such a condition. In order to alleviate the sensitivity to light so that the patient could be examined, two contact lenses were inserted into the patient's eyes, one being dark red, and one being substantially the same color as a Corning CPF® 550 lens. Within 20 minutes of inserting these lenses into the patient's eyes, her migraine pain had almost completely subsided. Within 15 seconds of placing the lenses into the patient's eyes, the migraine pain had begun to subside. The lenses that were permanently dispensed to this patient had a black dot in the middle of both lenses that was 5 millimeters in diameter, had a power of a 1.50 in both eyes, a diameter of 14.5 millimeters in both eyes, and a base curve of 8.3 millimeters in both eyes. Using the contact lenses according to the present invention, the patient was able to use an illuminated hand magnifier to improve her vision to 20/40 at near distances. The patient should be monitored after insertion of the lenses to determine if the headache symptoms have been alleviated. Normally, this is done by making verbal inquiries of the patient and recording responses.

The next patient to be treated with the lenses of the present invention was a male that suffered from recurring migraine headaches as diagnosed by a medical doctor. The patient also suffered from photophobia, and pain. For the treatment of these various conditions, the patient was taking several different medications. The patient was normally sighted meaning that, when he was not in pain from some other condition, he could see substantially as well as a normal person. This patient was treated with one light red lens and one dark red lens. After wearing the lenses for approximately 2 hours, the patient had absolutely no pain, and could look at the television and go outside into the sunlight.

The third patient was a female that had previously been diagnosed by a medical doctor with migraine headaches and as having asymmetric optic nerves. This patient often experienced migraine headaches in conjunction with her menstrual cycle. The patient presented with a very painful migraine headache, accompanied by nausea and photophobia. The migraine was reported to have been ongoing for the previous 18 hours. Her pain was focused on the left side of her head, and tapered from above the left eye to behind the left ear and terminated at the base of the neck. The pain was so severe that she had to have the lights off or her eyes closed, and had to walk very slowly being led by the hand. The only contact lenses on hand during that first visit were one dark red lens and one lens a lighter red that substantially matched the Coming CPF® 550 lens in color. The dark red lens was inserted into the eye corresponding to the side of the head experiencing the greatest amount of pain. The lenses were inserted at 11:45 am. At 11:47 am, the patient's speech was slightly more animated and faster. At 11:50 am, the patient was able to hold her eyes open. At 11:54 am, her hearing was not as sensitive. At 12:00 pm the patient was able to sit in the examination room with the lights on and her eyes open. At 1:20 pm, the patient was allowed to return to work. By 3:10 pm, the patient reported that her migraine headache was completely gone and that she merely suffered from some residual muscle tenderness. The patient had normal vision and therefore piano lenses were prescribed, meaning that they had no focusing power (neither plus nor minus). The prescribed lenses had a diameter of 14.0 millimeters and a base curve of 8.6 millimeters. The patient went through her next menstrual cycle using the lenses of the present invention without any migraine headache pain, and without the use of any medication.

The fourth patient was diagnosed by a medical doctor with migraine headaches, high blood pressure, diabetes, cardiovascular problems, and asthma. This patient had experienced occasional migraine headaches for the previous 50 years, and at the time of her initial visit was experiencing migraine headaches approximately twice per month. The weekend prior to her first visit, the patient had been seen in the emergency room where she had been given several injections to relieve her pain.

The injections were ineffective to relieve her pain. On the day of her visit, she had been given Maxalt for pain relief. The Maxalt did not work either. The dominant migraine pain was focused on the left hemisphere of her head, she was being led by the hand, with eyes closed, wearing dark sunglasses and using a cane. The only lenses on hand at the time of this patient's visit were one light red and one dark red. The darker color lens was inserted into the left eye because that was where the dominant hemisphere of pain was occurring. After placing the lenses in the patient's eyes at approximately 1:00 pm, she was allowed to sit in the dark for several minutes. Almost immediately she could open her eyes and smiled. At 1:40 pm all headache symptoms had completely disappeared. By 2:00 pm the patient remained free of pain and was able to move around on her own, walk to the cafeteria and eat. The patient was released at approximately 4:30 pm, still headache free.

To date 43 patients have been treated for migraine pain using the contact lenses of the present invention. Four of these patients have been described above, and 39 others have been treated using two rust-red lenses, one in each eye. Of the 43 patients treated, only 3 patients did not experience any relief from their symptoms through the use of the contact lenses of the present invention. The 39 successful treatments have been of patients that were actually diagnosed with migraine headaches by a medical doctor. The three patients that did not experience any pain relief were never diagnosed by a medical doctor with migraine pain, and therefore the cause of their head pain is not known.

Those of skill in the art will recognize that the invention is subject to numerous modifications and changes without falling outside of the scope of the attached claims.

What is claimed is:

1. A method of treatment of a patient with a migraine headache comprising the steps of:
inserting into one of the eyes of the patient a contact lens having a color that filters out light having a wavelength of from about 411 nanometers to about 550 nanometers; and
monitoring the patient for relief from headache symptoms.

2. The method of claim 1 wherein the lens has a rust red color.

3. The method of claim 1 wherein the lens filters out about 80% of visible spectrum light.

4. The method of claim 2 further comprising the step of inserting a second contact lens into a second eye of the patient.

5. The method of claim 4 wherein the second lens has a dark red color.

6. The method of claim 4 wherein the second lens has a red color.

7. The method of claim 4 wherein the second lens has a rust red color.

8. A contact lens for treatment of migraine headaches, comprising:
a lens body having a color that filters out light having a wavelength of from about 411 nanometers to about 550 nanometers.

9. The lens of claim of claim 8 wherein the lens has a red color.

10. The lens of claim 8 wherein the lens has a rust red color.

11. The lens of claim 8 wherein the lens has a dark red color.

12. The lens of claim 8 wherein the lens filters out approximately 80% of visible spectrum light.

13. A method of treatment for migraine headache comprising the steps of:
providing a pair of contact lenses that filter out approximately 80% of visible spectrum light having a wavelength of from about 411 nanometers to about 550 nanometers;
inserting at least one contact lens into an eye; and
determining whether headache symptoms have been relieved.

14. The method of claim 13 wherein the insertion step comprises inserting a contact lens into each eye.

15. The method of claim 14 wherein the lenses each have a color that is from 600 nanometers to about 700 nanometers.

16. The method of claim 15 wherein the lenses have a brownish-red color.

17. The method of claim 15 wherein the lenses have a rust red color.

18. The method of claim 15 wherein the lenses are of substantially the same color.

19. The method of claim 15 wherein the lenses have different colors.

20. The method of claim 19 wherein one of said pair of lenses is a dark red color and the other of said pair of lenses is a rust red color.
